(19) United States
(12) Patent Application Publication
(10) Pub. No.: US 2020/0393535 A1
(43) Pub. Date: Dec. 17, 2020

(54) METHOD, SYSTEM AND APPARATUS

(71) Applicant: NOKIA TECHNOLOGIES OY, Espoo (FI)

(72) Inventor: Lei SU, Shenzhen (CN)

(73) Assignee: NOKIA TECHNOLOGIES OY, Espoo (FI)

(21) Appl. No.: 16/962,078

(22) PCT Filed: Jan. 15, 2018
(86) PCT No.: PCT/CN2018/072666

§ 371 Date: Jul. 14, 2020

(51) Int. Cl. G01S 7/02; G01S 7/36; H04W 64/00

(52) U.S. Cl. CPC G01S 7/023; G01S 2205/008; H04W 64/003; G01S 7/36

(57) ABSTRACT

An apparatus comprising at least one processor, and at least one memory including computer program code, wherein the at least one memory and the computer program code are configured, with the at least one processor, to cause the apparatus to: generate at least one message for a further apparatus, the at least one message comprising information associated with at least one radio characteristic of the apparatus; define at least one radio interference threshold value; receive a radio signal having a signal value greater than the at least one radio interference threshold value, the radio signal being a radio signal originating from an radio system type other than the apparatus; measure the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

### FIELD

The present application relates to a method, apparatus, and computer program and in particular but not exclusively to methods, apparatus, and computer programs related to identification of abnormal or interference wireless sources over multiple systems.

### BACKGROUND

The radio frequency spectrum is a congested space and is generally heavily regulated to prevent interference from one system from interfering with other systems. For example typically radar systems will operate within a first frequency range, cellular communications systems over further frequency ranges and licensed and unlicensed radio communications and data systems (such as emergency services systems, public or citizen band radio, UAV/drone remote control data) over other frequency ranges.

In theory each of the systems are designed not to interfere with each other. However an abnormal wireless signal due to equipment failure or other causes can lead to interference being received in radio equipment that normally uses the frequency.

For interference sources and interfering devices within the same technical specification system it is typically possible to determine the location of the interference source and take appropriate action by querying any information such as the location of the device inside the system. Thus for example interference between radars can be detected and can be reported or controlled. Similarly within a cellular communications system interference between base stations can be detected and allowed for and/or controlled.

However for those interference sources and interfering devices that do not belong to the same technical specification, it is necessary to determine the type and location of the interference source in order to be able to then take an appropriate further action. For example determining interference between radar and base stations and generating a suitable report to enable the radar to be repaired and stop interfering on the base station or vice versa.

### SUMMARY

In a first aspect there is provided an apparatus comprising at least one processor, and at least one memory including computer program code, wherein the at least one memory and the computer program code are configured, with the at least one processor, to cause the apparatus to: generate at least one message for a further apparatus, the at least one message comprising information associated with at least one radio characteristic of the apparatus; define at least one radio interference threshold value; receive a radio signal having a signal value greater than the at least one radio interference threshold value, the radio signal being a radio signal originating from an radio system type other than the apparatus; and measure the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

The apparatus caused to generate at least one message for a further apparatus, the at least one message comprising information associated with at least one radio characteristic of the apparatus may be caused to generate the at least one message comprising at least one of: an apparatus location; an apparatus radio transmitter frequency; and an apparatus radio transmitter strength.

The apparatus caused to define at least one radio interference threshold value may be caused to: define at least one echo pulse loss threshold where the apparatus is a radar apparatus; and define a runtime ground noise threshold where the apparatus a cellular access point.

The apparatus caused to measure the radio signal to determine at least one radio signal characteristic may be caused to determine at least one of: an estimated interference source radio signal strength based on the received radio signal; an estimated interference source radio signal frequency based on the received radio signal; an estimated interference source direction based on the received radio signal; an estimated interference source distance based on the received radio signal; and an estimated interference source location based on the received radio signal.

The apparatus may be further caused to generate at least one distance message to an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

The apparatus may be caused to control the use of a radio frequency and/or time associated with radio signal such that the apparatus caused to measure the radio signal to determine at least one radio signal characteristic is caused to measure the radio signal when the apparatus or a radio system comprising the apparatus is active at the same frequency and/or time.

The apparatus caused to generate at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic may be caused to: generate a first, registration and/or update report, message comprising information associated with at least one radio characteristic of the apparatus; and generate a separate further, interference report, message comprising information associated with the at least one radio signal characteristic such that the further apparatus is caused to attempt to identify the radio signal based on the information associated with the at least one radio signal characteristic.

According to a second aspect there is provided an apparatus comprising at least one processor, and at least one memory including computer program code, wherein the at least one memory and the computer program code are configured, with the at least one processor, to cause the apparatus to: receive at least one message from at least one further apparatus, the at least one message comprising information associated with at least one radio characteristic of the at least one further apparatus and comprising information associated with at least one estimated radio signal characteristic of a determined interference source; generate a database of radio apparatus based on the at least one message; compare the information associated with at least one estimated radio signal characteristic of a determined interference source with the database of radio apparatus based on the at least one message in order to attempt to identify whether the determined interference source is known to the database of radio apparatus; and generate at least one message based on the comparison of the information associated with at least one estimated radio signal characteristic of a determined interference source with the database of radio apparatus based on the received at least one message.

The apparatus caused to receive at least one message from at least one further apparatus, the at least one message comprising information associated with at least one radio characteristic of the at least one further apparatus may be caused to receive at least one of: a further apparatus location; a further apparatus radio transmitter frequency; and a further apparatus radio transmitter strength.

The apparatus caused to receive at least one message, the at least one message comprising information associated with at least one estimated radio signal characteristic of a determined interference source may be further caused to receive at least one of: an estimated interference source radio signal strength; an estimated interference source radio signal frequency; an estimated interference source direction; an estimated interference source distance; and an estimated interference source location.

The apparatus caused to compare the information associated with at least one estimated radio signal characteristic of a determined interference source with the database of radio apparatus based on the at least one message in order to attempt to identify whether the determined interference source is known to the database of radio apparatus may be further caused to compare at least one of: the estimated interference source location with locations within the database of radio apparatus to identify radio apparatus at or near the estimated interference source location; the estimated interference source radio signal frequency with frequencies within the database of radio apparatus to identify radio apparatus at or near the estimated interference source frequency; and the estimated interference source radio signal strength with transmitter strengths within the database of radio apparatus to identify radio apparatus at or near the estimated interference source strength.

The apparatus caused to generate at least one message based on the comparison of the information associated with at least one estimated radio signal characteristic of a determined interference source with the database of radio apparatus based on the at least one message may be caused to: generate at least one control and/or reporting message based on the comparison identifying the interference source with the database of radio apparatus; and generate at least one reporting message based on the comparison failing to identify the interference source with the database of radio apparatus.

The apparatus may be further caused to update the database of radio apparatus based on the comparison failing to identify the interference source with the database of radio apparatus.

The apparatus caused to receive at least one message from at least one further apparatus, the at least one message comprising information associated with at least one radio characteristic of the at least one further apparatus and comprising information associated with at least one estimated radio signal characteristic of a determined interference source may be caused to receive: at least one registration and/or update message comprising the information associated with at least one radio characteristic of the at least one further apparatus; and at least one interference reporting message comprising the information associated with at least one estimated radio signal characteristic of a determined interference source.

According to a third aspect there is provided a method comprising: generating, at an apparatus, at least one message for a further apparatus, the at least one message comprising information associated with at least one radio characteristic of the apparatus; defining at least one radio interference threshold value; receiving a radio signal having a signal value greater than the at least one radio interference threshold value, the radio signal being a radio signal originating from an radio system type other than the apparatus; and measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

Generating, at an apparatus, at least one message for a further apparatus, the at least one message comprising information associated with at least one radio characteristic of the apparatus may comprise generating the at least one message comprising at least one of: an apparatus location; an apparatus radio transmitter frequency; and an apparatus radio transmitter strength.

Defining at least one radio interference threshold value may comprise: defining at least one echo pulse loss threshold where the apparatus is a radar apparatus; and defining a runtime ground noise threshold where the apparatus a cellular access point.

Measuring the radio signal to determine at least one radio signal characteristic may comprise determining at least one of: an estimated interference source radio signal strength based on the received radio signal; an estimated interference source radio signal frequency based on the received radio signal; an estimated interference source direction based on the received radio signal; an estimated interference source distance based on the received radio signal; and an estimated interference source location based on the received radio signal.

The method may further comprise generating, at the apparatus, at least one distance message for an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

The method may further comprise controlling the use of a radio frequency and/or time associated with radio signal such that measuring the radio signal to determine at least one radio signal characteristic comprises measuring the radio signal when the apparatus or a radio system comprising the apparatus is active at the same frequency and/or time.

Generating, at the apparatus, at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic may comprise: generating a first, registration and/or update report, message comprising information associated with at least one radio characteristic of the apparatus; and generating a separate further, interference report, message comprising information associated with the at least one radio signal characteristic such that the further apparatus is caused to attempt to identify the radio signal based on the information associated with the at least one radio signal characteristic.

According to a fourth aspect there is provided a method comprising: receiving, at an apparatus, at least one message from at least one further apparatus, the at least one message comprising information associated with at least one radio characteristic of the at least one further apparatus and comprising information associated with at least one estimated radio signal characteristic of a determined interference source; generating a database of radio apparatus based on the at least one message; comparing the information associated with at least one estimated radio signal characteristic of a determined interference source with the database of radio apparatus based on the at least one message in order to attempt to identify whether the determined interference source is known to the database of radio apparatus; generating, at the apparatus, at least one message based on the comparison of the information associated with at least one estimated radio signal characteristic of a determined interference source with the database of radio apparatus based on the received at least one message.

Receiving, at an apparatus, at least one message from at least one further apparatus, the at least one message comprising information associated with at least one radio characteristic of the at least one further apparatus may comprise receiving at least one of: a further apparatus location; a further apparatus radio transmitter frequency; and a further apparatus radio transmitter strength.

Receiving, at an apparatus, at least one message, the at least one message comprising information associated with at least one estimated radio signal characteristic of a determined interference source may comprise receiving at least one of: an estimated interference source radio signal strength; an estimated interference source radio signal frequency; an estimated interference source direction; an estimated interference source distance; and an estimated interference source location.

Comparing the information associated with at least one estimated radio signal characteristic of a determined interference source with the database of radio apparatus based on the at least one message in order to attempt to identify whether the determined interference source is known to the database of radio apparatus may comprise comparing at least one of: the estimated interference source location with locations within the database of radio apparatus to identify radio apparatus at or near the estimated interference source location; the estimated interference source radio signal frequency with frequencies within the database of radio apparatus to identify radio apparatus at or near the estimated interference source frequency; and the estimated interference source radio signal strength with transmitter strengths within the database of radio apparatus to identify radio apparatus at or near the estimated interference source strength.

Generating at least one message based on the comparison of the information associated with at least one estimated radio signal characteristic of a determined interference source with the database of radio apparatus based on the at least one message may comprise: generating at least one control and/or reporting message based on the comparison identifying the interference source with the database of radio apparatus; and generating at least one reporting message based on the comparison failing to identify the interference source with the database of radio apparatus.

The method may further comprise updating the database of radio apparatus based on the comparison failing to identify the interference source with the database of radio apparatus.

Receiving, at the apparatus, at least one message from at least one further apparatus, the at least one message comprising information associated with at least one radio characteristic of the at least one further apparatus and comprising information associated with at least one estimated radio signal characteristic of a determined interference source may comprise receiving: at least one registration and/or update message comprising the information associated with at least one radio characteristic of the at least one further apparatus; and at least one interference reporting message comprising the information associated with at least one estimated radio signal characteristic of a determined interference source.

According to a fifth aspect there is provided an apparatus comprising: means for generating at least one message for a further apparatus, the at least one message comprising information associated with at least one radio characteristic of the apparatus; means for defining at least one radio interference threshold value; means for receiving a radio signal having a signal value greater than the at least one radio interference threshold value, the radio signal being a radio signal originating from an radio system type other than the apparatus; and means for measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

The means for generating at least one message for a further apparatus, the at least one message comprising information associated with at least one radio characteristic of the apparatus may comprise generating the at least one message comprising at least one of: an apparatus location; an apparatus radio transmitter frequency; and an apparatus radio transmitter strength.

The means for defining at least one radio interference threshold value may comprise: means for defining at least one echo pulse loss threshold where the apparatus is a radar apparatus; and means for defining a runtime ground noise threshold where the apparatus a cellular access point.

The means for measuring the radio signal to determine at least one radio signal characteristic may comprise means for determining at least one of: an estimated interference source radio signal strength based on the received radio signal; an estimated interference source radio signal frequency based on the received radio signal; an estimated interference source direction based on the received radio signal; an estimated interference source distance based on the received radio signal; and an estimated interference source location based on the received radio signal.

The apparatus may further comprise means for generating at least one distance message for an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

The apparatus may further comprise means for controlling the use of a radio frequency and/or time associated with radio signal such that measuring the radio signal to determine at least one radio signal characteristic comprises means for measuring the radio signal when the apparatus or a radio system comprising the apparatus is active at the same frequency and/or time.

The means for generating at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic may comprise: means for generating a first, registration and/or update report, message comprising information associated with at least one radio characteristic of the apparatus; and means for generating a separate further, interference report, message comprising information associated with the at least one radio signal characteristic such that the further apparatus is caused to attempt to identify the radio signal based on the information associated with the at least one radio signal characteristic.

According to a sixth aspect there is provided an apparatus comprising: means for receiving at least one message from at least one further apparatus, the at least one message comprising information associated with at least one radio characteristic of the at least one further apparatus and comprising information associated with at least one estimated radio signal characteristic of a determined interference source; means for generating a database of radio apparatus based on the at least one message; means for comparing the information associated with at least one estimated radio signal characteristic of a determined interference source with the database of radio apparatus based on the at least one message in order to attempt to identify whether the determined interference source is known to the database of radio apparatus; and means for generating, at the apparatus, at least one message based on the comparison of the information associated with at least one estimated radio signal characteristic of a determined interference source with the database of radio apparatus based on the received at least one message.

The means for receiving at least one message from at least one further apparatus, the at least one message comprising information associated with at least one radio characteristic of the at least one further apparatus may comprise means for receiving at least one of: a further apparatus location; a further apparatus radio transmitter frequency; and a further apparatus radio transmitter strength.

The means for receiving at least one message, the at least one message comprising information associated with at least one estimated radio signal characteristic of a determined interference source may comprise means for receiving at least one of: an estimated interference source radio signal strength; an estimated interference source radio signal frequency; an estimated interference source direction; an estimated interference source distance; and an estimated interference source location.

The means for comparing the information associated with at least one estimated radio signal characteristic of a determined interference source with the database of radio apparatus based on the at least one message in order to attempt to identify whether the determined interference source is known to the database of radio apparatus may comprise means for comparing at least one of: the estimated interference source location with locations within the database of radio apparatus to identify radio apparatus at or near the estimated interference source location; the estimated interference source radio signal frequency with frequencies within the database of radio apparatus to identify radio apparatus at or near the estimated interference source frequency; and the estimated interference source radio signal strength with transmitter strengths within the database of radio apparatus to identify radio apparatus at or near the estimated interference source strength.

The means for generating at least one message based on the comparison of the information associated with at least one estimated radio signal characteristic of a determined interference source with the database of radio apparatus based on the at least one message may comprise: means for generating at least one control and/or reporting message based on the comparison identifying the interference source with the database of radio apparatus; and means for generating at least one reporting message based on the comparison failing to identify the interference source with the database of radio apparatus.

The apparatus may further comprise means for updating the database of radio apparatus based on the comparison failing to identify the interference source with the database of radio apparatus.

The means for receiving at least one message from at least one further apparatus, the at least one message comprising information associated with at least one radio characteristic of the at least one further apparatus and comprising information associated with at least one estimated radio signal characteristic of a determined interference source may comprise means for receiving: at least one registration and/or update message comprising the information associated with at least one radio characteristic of the at least one further apparatus; and at least one interference reporting message comprising the information associated with at least one estimated radio signal characteristic of a determined interference source.

According to a seventh aspect there is provided a computer program comprising instructions for causing an apparatus to perform at least the following: generating at least one message for a further apparatus, the at least one message comprising information associated with at least one radio characteristic of the apparatus; defining at least one radio interference threshold value; receiving a radio signal having a signal value greater than the at least one radio interference threshold value, the radio signal being a radio signal originating from an radio system type other than the apparatus; measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

Generating at least one message for a further apparatus, the at least one message comprising information associated with at least one radio characteristic of the apparatus may cause an apparatus to perform generating the at least one message comprising at least one of: an apparatus location; an apparatus radio transmitter frequency; and an apparatus radio transmitter strength.

Defining at least one radio interference threshold value may cause an apparatus to perform: defining at least one echo pulse loss threshold where the apparatus is a radar apparatus; and defining a runtime ground noise threshold where the apparatus a cellular access point.

Measuring the radio signal to determine at least one radio signal characteristic may cause an apparatus to perform determining at least one of: an estimated interference source radio signal strength based on the received radio signal; an estimated interference source radio signal frequency based on the received radio signal; an estimated interference source direction based on the received radio signal; an estimated interference source distance based on the received radio signal; and an estimated interference source location based on the received radio signal.

The computer program may further cause an apparatus to perform at least the following generating at least one distance message for an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

The computer program may further cause an apparatus to perform at least the following controlling the use of a radio frequency and/or time associated with radio signal such that measuring the radio signal to determine at least one radio signal characteristic causes an apparatus to perform measuring the radio signal when the apparatus or a radio system comprising the apparatus is active at the same frequency and/or time.

Generating at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic may cause an apparatus to perform: generating a first, registration and/or update report, message comprising information associated with at least one radio characteristic of the apparatus; and generating a separate further, interference report, message comprising information associated with the at least one radio signal characteristic such that the further apparatus is caused to attempt to identify the radio signal based on the information associated with the at least one radio signal characteristic.

According to an eighth aspect there is provided a computer program comprising instructions for causing an apparatus to perform at least the following: receiving at least one message from at least one further apparatus, the at least one message comprising information associated with at least one radio characteristic of the at least one further apparatus and comprising information associated with at least one estimated radio signal characteristic of a determined interference source; generating a database of radio apparatus based on the at least one message; comparing the information associated with at least one estimated radio signal characteristic of a determined interference source with the database of radio apparatus based on the at least one message in order to attempt to identify whether the determined interference source is known to the database of radio apparatus; generating at least one message based on the comparison of the information associated with at least one estimated radio signal characteristic of a determined interference source with the database of radio apparatus based on the received at least one message.

Receiving at least one message from at least one further apparatus, the at least one comprising message information associated with at least one radio characteristic of the at least one further apparatus may cause an apparatus to perform receiving at least one of: a further apparatus location; a further apparatus radio transmitter frequency; and a further apparatus radio transmitter strength.

Receiving at least one message, the at least one message comprising information associated with at least one estimated radio signal characteristic of a determined interference source may cause an apparatus to perform receiving at least one of: an estimated interference source radio signal strength; an estimated interference source radio signal frequency; an estimated interference source direction; an estimated interference source distance; and an estimated interference source location.

Comparing the information associated with at least one estimated radio signal characteristic of a determined interference source with the database of radio apparatus based on the at least one message in order to attempt to identify whether the determined interference source is known to the database of radio apparatus may cause an apparatus to perform comparing at least one of: the estimated interference source location with locations within the database of radio apparatus to identify radio apparatus at or near the estimated interference source location; the estimated interference source radio signal frequency with frequencies within the database of radio apparatus to identify radio apparatus at or near the estimated interference source frequency; and the estimated interference source radio signal strength with transmitter strengths within the database of radio apparatus to identify radio apparatus at or near the estimated interference source strength.

Generating at least one message based on the comparison of the information associated with at least one estimated radio signal characteristic of a determined interference source with the database of radio apparatus based on the at least one message may cause an apparatus to perform: generating at least one control and/or reporting message based on the comparison identifying the interference source with the database of radio apparatus; and generating at least one reporting message based on the comparison failing to identify the interference source with the database of radio apparatus.

The computer program may further cause an apparatus to perform at least the following updating the database of radio apparatus based on the comparison failing to identify the interference source with the database of radio apparatus.

Receiving at least one message from at least one further apparatus, the at least one message comprising information associated with at least one radio characteristic of the at least one further apparatus and comprising information associated with at least one estimated radio signal characteristic of a determined interference source may cause an apparatus to perform receiving: at least one registration and/or update message comprising the information associated with at least one radio characteristic of the at least one further apparatus; and at least one interference reporting message comprising the information associated with at least one estimated radio signal characteristic of a determined interference source.

According to a ninth aspect there is provided a computer readable medium comprising program instructions for causing an apparatus to perform at least the following: generating at least one message for a further apparatus, the at least one message comprising information associated with at least one radio characteristic of the apparatus; defining at least one radio interference threshold value; receiving a radio signal having a signal value greater than the at least one radio interference threshold value, the radio signal being a radio signal originating from an radio system type other than the apparatus; measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

Generating at least one message for a further apparatus, the at least one message comprising information associated with at least one radio characteristic of the apparatus may cause an apparatus to perform generating the at least one message comprising at least one of: an apparatus location; an apparatus radio transmitter frequency; and an apparatus radio transmitter strength.

Defining at least one radio interference threshold value may cause an apparatus to perform: defining at least one echo pulse loss threshold where the apparatus is a radar apparatus; and defining a runtime ground noise threshold where the apparatus a cellular access point.

Measuring the radio signal to determine at least one radio signal characteristic may cause an apparatus to perform determining at least one of: an estimated interference source radio signal strength based on the received radio signal; an estimated interference source radio signal frequency based on the received radio signal; an estimated interference source direction based on the received radio signal; an estimated interference source distance based on the received radio signal; and an estimated interference source location based on the received radio signal.

The computer readable medium may further cause an apparatus to perform at least the following generating at least one distance message for an interference source determiner, the at least one distance message comprising information associated with an estimate of the distance of the radio signal such that the interference source determiner is caused to perform receiving two or more distance messages from two or more separate apparatus and estimating a radio signal location based on the two or more distance messages and the location of the two or more separate apparatus.

The computer readable medium may further cause an apparatus to perform at least the following controlling the use of a radio frequency and/or time associated with radio signal such that measuring the radio signal to determine at least one radio signal characteristic causes an apparatus to perform measuring the radio signal when the apparatus or a radio system comprising the apparatus is active at the same frequency and/or time.

Generating at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic may cause an apparatus to perform: generating a first, registration and/or update report, message comprising information associated with at least one radio characteristic of the apparatus; and generating a separate further, interference report, message comprising information associated with the at least one radio signal characteristic such that the further apparatus is caused to attempt to identify the radio signal based on the information associated with the at least one radio signal characteristic.

According to a tenth aspect there is provided a computer readable medium comprising program instructions for causing an apparatus to perform at least the following: receiving at least one message from at least one further apparatus, the at least one message comprising information associated with at least one radio characteristic of the at least one further apparatus and comprising information associated with at least one estimated radio signal characteristic of a determined interference source; generating a database of radio apparatus based on the at least one message; comparing the information associated with at least one estimated radio signal characteristic of a determined interference source with the database of radio apparatus based on the at least one message in order to attempt to identify whether the determined interference source is known to the database of radio apparatus; generating at least one message based on the comparison of the information associated with at least one estimated radio signal characteristic of a determined interference source with the database of radio apparatus based on the received at least one message.

Receiving at least one message from at least one further apparatus, the at least one comprising message information associated with at least one radio characteristic of the at least one further apparatus may cause an apparatus to perform receiving at least one of: a further apparatus location; a further apparatus radio transmitter frequency; and a further apparatus radio transmitter strength.

Receiving at least one message, the at least one message comprising information associated with at least one estimated radio signal characteristic of a determined interference source may cause an apparatus to perform receiving at least one of: an estimated interference source radio signal strength; an estimated interference source radio signal frequency; an estimated interference source direction; an estimated interference source distance; and an estimated interference source location.

Comparing the information associated with at least one estimated radio signal characteristic of a determined interference source with the database of radio apparatus based on the at least one message in order to attempt to identify whether the determined interference source is known to the database of radio apparatus may cause an apparatus to perform comparing at least one of: the estimated interference source location with locations within the database of radio apparatus to identify radio apparatus at or near the estimated interference source location; the estimated interference source radio signal frequency with frequencies within the database of radio apparatus to identify radio apparatus at or near the estimated interference source frequency; and the estimated interference source radio signal strength with transmitter strengths within the database of radio apparatus to identify radio apparatus at or near the estimated interference source strength.

Generating at least one message based on the comparison of the information associated with at least one estimated radio signal characteristic of a determined interference source with the database of radio apparatus based on the at least one message may cause an apparatus to perform: generating at least one control and/or reporting message based on the comparison identifying the interference source with the database of radio apparatus; and generating at least one reporting message based on the comparison failing to identify the interference source with the database of radio apparatus.

The computer readable medium may further cause an apparatus to perform at least the following updating the database of radio apparatus based on the comparison failing to identify the interference source with the database of radio apparatus.

Receiving at least one message from at least one further apparatus, the at least one message comprising information associated with at least one radio characteristic of the at least one further apparatus and comprising information associated with at least one estimated radio signal characteristic of a determined interference source may cause an apparatus to perform receiving: at least one registration and/or update message comprising the information associated with at least one radio characteristic of the at least one further apparatus; and at least one interference reporting message comprising the information associated with at least one estimated radio signal characteristic of a determined interference source.

The apparatus may comprise at least one processor and at least one memory including computer code for one or more programs.

In another aspect there is provided a computer program embodied on a non-transitory computer-readable storage medium, the computer program comprising program code for providing any of the above methods.

In another aspect there is provided a computer program product for a computer, comprising software code portions for performing the steps of any of the previous methods, when said product is run.

A computer program comprising program code means adapted to perform the method(s) may be provided. The computer program may be stored and/or otherwise embodied by means of a carrier medium.

In the above, many different embodiments have been described. It should be appreciated that further embodiments may be provided by the combination of any two or more of the embodiments described above.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices including an aerial vehicle communication device;

FIG. 2a shows a schematic diagram of an example radio system device;

FIG. 2b shows a schematic diagram of an example location server database;

FIG. 3 shows a schematic view of an example radar system interference determiner according to some embodiments;

FIG. 4 shows a schematic view of an example radar system interference position determiner according to some embodiments;

FIG. 5 shows a schematic view of an example cellular communications system interference determiner according to some embodiments;

FIG. 6 shows a schematic view of an example interference source database according to some embodiments;

FIG. 7 shows a flow diagram of an overview of a multi-system interference determination operation according to some embodiments; and

FIG. 8 shows a flow diagram of the generation of a registration/update and interference report at an apparatus within the multi-system interference determination system according to some embodiments.

### DETAILED DESCRIPTION

The concept as discussed in further detail hereafter is one whereby a system is designed which can detect and characterize interfering sources and their position, even where the interfering source is not the same system type detecting the interference. In some embodiments this may be implemented by an apparatus or device of a first system type being configured to detect the interference signal of a source from a different system type. Comparing characteristics of the detected interference source to stored device characteristics within a device database, an attempt to identify the interfering source type and location can be performed and appropriate action taken.

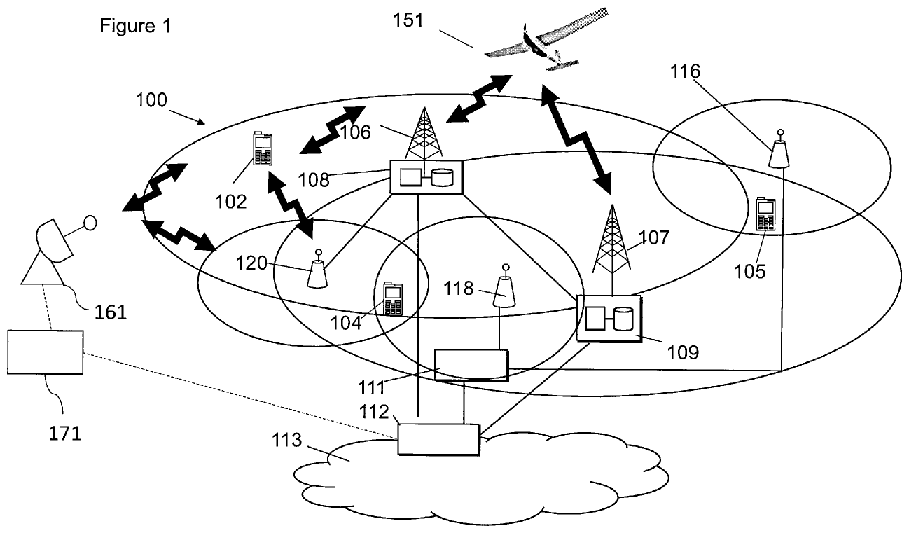

FIG. 1 shows a general system within with embodiments may be implemented. The system 100 shown in FIG. 1 comprises a cellular based wireless communications system and other wireless systems such as an unmanned aerial vehicle (UAV) and radar system however the system may comprise any wireless communications or data network.

Within the system 100, such as that shown in FIG. 1, the cellular communications system is shown comprising conventional mobile communication devices or user equipment (UE) 102, 104, 105 which may be provided wireless access via at least one base station or similar wireless transmitting and/or receiving node or point. Base stations (BTS, NodeB (NB), enhanced NodeB (eNB), new generation NodeB (gNB)) and may be typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller or a base station controller (BSC).

The system may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

As discussed previously the system 100 may further comprise an (unmanned) aerial vehicle (UAV) 151. The UAV may in some embodiments be equipped with user equipment, mobile station or communications device capability. Furthermore in some embodiments the UAV 151 may be equipped with radio range and direction (radar) capability. As such the UAV 151 (with wireless communication system capability and/or radar capability) may interfere with the cellular communications system described previously and other radar systems, such as the radar system 161 shown in FIG. 1.

The UAV 151 may be any suitable AV. For example the UAV may be a lighter-than-air vehicle such as an airship or dirigible balloon, or may be a heavier-than-air vehicle such as aeroplane or helicopter. In some embodiments the AV is manned and may in some embodiments be autonomously or partially autonomously controlled.

The system 100 as shown in FIG. 1 may also comprise one or more fixed or mobile radar systems, shown in FIG. 1 by reference 161. The radar system may be any suitable radar system, for example a continuous wave system, a pulse system etc.

As shown in FIG. 1 there are many different possible sources of interference, from interference between the UAV 151 and the base stations 106, 107, interference between the base station 120 and the radar system 161, interference between the radar system and handsets or UEs 102. Potential interference is for example shown in FIG. 1 by the dark thick arrows between the radio apparatus.

Also shown in the system according to some embodiments is the location server database 171. The location server database 171 may be any suitable device or devices configured to communicate with radio system devices either directly, as shown in FIG. 1 by the direct coupling between the location server database 171 and the radar system 161 or indirectly, such as shown in FIG. 1 by the indirect coupling between the basestation 106/107 and location server database 171 via the core network part 112 of the communications system.

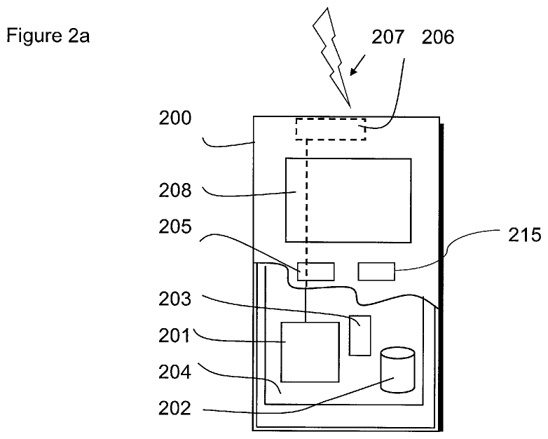

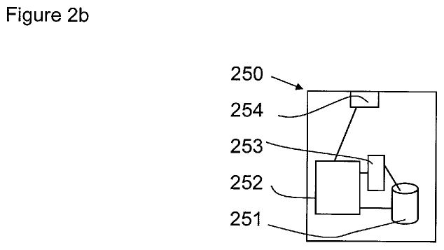

A possible schematic view of a radio system or wireless device, for example a mobile communication device or UE, a UAV, an access point or base station, a radar system, according to some embodiments is shown in FIG. 2a. Such a radio system device 200 may be provided by any device capable of sending and receiving radio signals.

The radio system device 200 may provide, for example when implemented as a UAV 151 may be enabled for communication of data for carrying communications such as voice, electronic mail (email), text message, multimedia, AV telemetry, AV captured images, control signals for controlling the AV, and so on. Non-limiting examples of services provided by the communications comprise data communication for example telemetry and/or images from the UAV to a remote operator and control or commands issued by the remote operator to the UAV for controlling the UAV.

The radio system device 200 may receive signals over an air or radio interface 207 via appropriate apparatus for receiving (e.g., a receiver) and may transmit signals via appropriate apparatus for transmitting radio signals (e.g., a transmitter). In FIG. 2a transceiver apparatus is designated schematically by block 206. The transceiver apparatus 206 may be provided for example by means of a radio part and associated antenna arrangement. The antenna arrangement may be arranged internally or externally to the radio system device 200. The antenna may be able to be mechanically or electronically steered and may by omnidirectional or directional in nature.

The radio system device 200 may be provided with at least one data processing entity 201, at least one memory 202 and other possible components 203 for use in software and hardware aided execution of tasks it is designed to perform. For example when the radio system device is a radar system (either static or mobile—for example implemented with the UAV) the tasks involve pulse/wave shaping and signal processing of the received signal to determine radar based directional and distance values. Similarly the radio system device when a UAV may including control of access to and communications with access systems and other communication devices. The data processing, storage and other relevant control apparatus can be provided on an appropriate circuit board and/or in chipsets. This feature is denoted by reference 204. The radio system device 200 may be further controlled by means of a suitable interface such as input/output ports 205 and 215. For example radio system device 200 may be controlled via voice commands, touch sensitive screen or pad, combinations thereof or the like. The radio system device 200 may in some embodiments be equipped with a display 208, a speaker and a microphone.

FIG. 2b shows an example implementation of a location server database apparatus 250 according to some embodiments for example to be coupled to and/or for receiving information from the radio system device 200. The location server database 250 may be implemented as a single node or distributed nodes of a network. The location server database 250 comprises at least one memory 251, at least one data processing unit 252, 253 and an input/output interface 254. Via the interface the control apparatus can be coupled to a receiver and a transmitter, for example to communicate with the radio system device 200.

As discussed above the concept discussed hereafter in further detail is identifying and classifying where possible an inter-system interference source efficiently.

The concept as discussed in detail hereafter is based on initially defining or setting a suitable interference threshold for the radio system device. Thus when the radio system device is a radar implementation in some embodiments an echo pulse loss threshold is defined for the radar system. When the radio system device is a base station/access point implementation then a ground noise threshold is defined for the base station/access point.

Having defined a suitable interference threshold for the radio system device the concept as discussed in detail hereafter is one of then measuring the interfering source without the radio system device transmitting in order to be able to determine interference source parameters such as direction and/or distance relative to the radio system device.

Thus for example the radar system, during a radar wave launch intermittent period, is configured to use the echo signal strength, frequency of the interference and the antenna inclination to calculate the distance and height and/or azimuth of the interference source.

Furthermore the example with respect to an access point/base station is configured to use the disturbed physical resource block (PRB), in the time when the PRB is not used, in order to measure the intensity and frequency of the interfering signal.

Having measured the interfering signal then radio system device may then calculate the position of the interference source from the measurements. For example the position of the interference source may then be determined by the distance and height of the interference source measured by two radar systems. Similarly based on the intensity and frequency of the interfering signal the base station may determine the position of the interference source.

The radio system device (for example the base stations and the radar system) may then be configured to upload the measured location of the interference source and a corresponding position's query radius to a location server database. The location server database is configured to store a list of radio system device (and associated information such as type, controllability etc.) and the location of the radio system device and from the location server database be able to identify and categorize the interference source. For example the location server database 171 may receive the reports from the radio system devices 161, 106 and based on the location information obtain the device type of the interference source by data matching.

In some embodiments where the location server database 171 is unable to identify the interference source then an unknown interference source may be identified and information gathered on the unknown interference source. For example in military operations, radar interference sources with unknown type in the database are likely to be the enemy equipment.

The concept may further extend to the embodiments where in order to effectively monitor and manage the use of radio frequency by the location server database 171, any fixed position radio equipment should report its equipment type and physical location to a device management database, after the installation is complete. Similarly in some embodiments a mobile radio system device can be configured to real-time report their own position/location and device type, through the use of a satellite (GPS) or any other positioning system to get their own position.

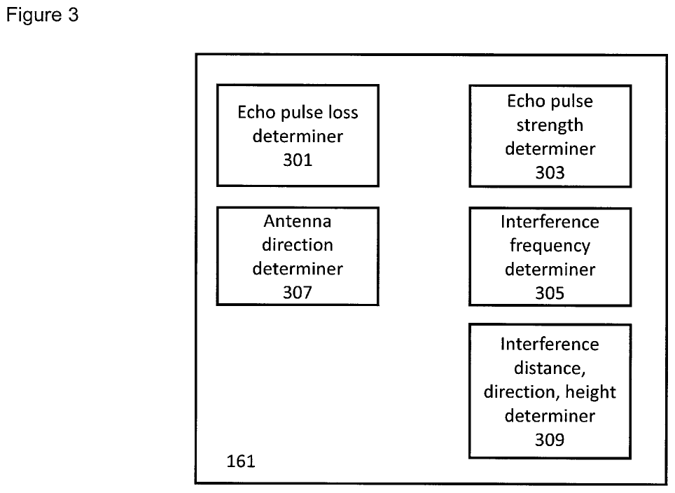

A schematic view of an example radar system 161 according to some embodiments is shown with respect to FIG. 3. The radar system 161 in some embodiments may comprise an echo pulse loss determiner 301, an echo pulse strength determiner 303, an echo pulse frequency determiner 305, an antenna direction determiner 307 and an interference distance/direction/height determiner 309.

In some embodiments the echo pulse loss determiner 301 is configured to define an echo pulse loss threshold for the radar system according to radar receiver decoding performance. This means the radar system is configured such that it is not enabled to measure the time difference between the transmitted pulse and the echo pulse where an echo pulse loss exceeds the threshold. In some embodiments the threshold echo pulse loss value is set to be 25%, but it is understood that the loss value may be any suitable value.

In some embodiments the echo pulse strength determiner 303 is configured to determine or estimate an interference signal strength occurring within an expected echo window period.

Similarly in some embodiments the echo pulse frequency determiner 305 is configured to determine or estimate an interference signal frequency occurring within an expected echo window period.

The antenna direction determiner 307 may be configured to determine the mechanical or electronic direction of the antenna receiving the interference signal. In some embodiments the antenna direction determiner 307 is configured to determine an azimuth and/or elevation of the antenna.

The interference distance/direction/height determiner 309 may be configured to perform interference source parameter estimation based on at least one of the determined interference signal strength, the determined interference signal frequency and the determined antenna direction.

For example where the radar system detects an echo pulse loss which exceeds the threshold, the radar system may be configured using the ‘echo’ determiners 303, 305 to start a time window for interference measurement. During the window, the radar system is configured to not launch or transmit any signals. Furthermore using the determined interference signal strength, frequency and antenna direction the interference distance/direction/height determiner 309 may be configured to calculate an interference signal source distance and/or height using a Free Space Path Loss (FSPL) method. For example the following formula may be used:

Distance (meter)=10\hat{ }((27.55−(20*log 10(frequency (MHz)))+signal level (dbm))/20)

Height=Sin(Radar antenna inclination)*Distance

In some embodiments the interference distance/direction/height determiner 309 may be further configured to calculate or estimate the azimuth direction of the interference source. With knowledge of the position of the radar system, the azimuth direction of the interference source and the distance of the interference source then the position of the interference source may be determined and reported.

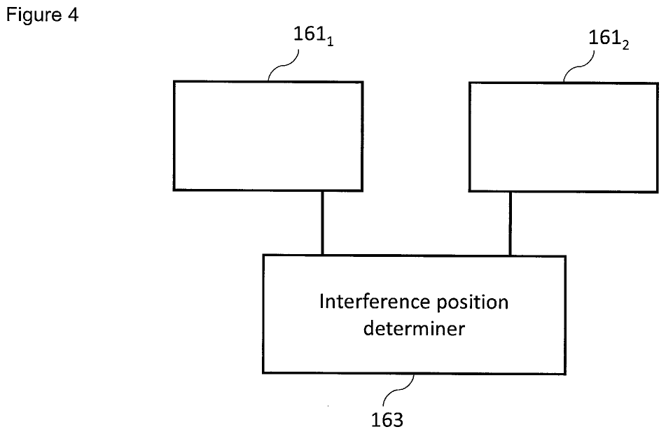

However in the following example the radar system is unable to determine the azimuth direction, only the height or elevation components. In such examples the source position may be determined by collating the determinations from multiple radar system in a manner such as shown in FIG. 4.

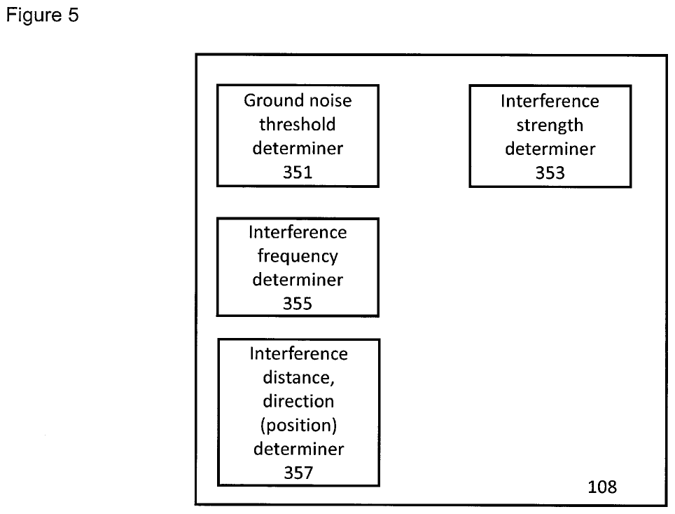

FIG. 4 shows a radar system interference position determiner 163 configured to receive distance and height values of an interference source from a pair of radar systems 161₁ and 161₂. Although two radar systems are shown in FIG. 5 there may be more than two systems communicating with the radar system interference position determiner 163.

The interference position determiner 163 in some embodiments is physically located at one or other of the radar systems or at a further location or locations. The interference position determiner 163 is configured to receive the distance and height values, along with the radar system location information and from these determine an estimated location of the interference source. For example in some embodiments the position determiner is configured to triangulate the location of the information source based on an intersection of circles centred at the location of the radar systems and where each circle has a radius defined by the determined distance of the interference source.

In some embodiments this information is then passed to the location server database 171.

A schematic view of an example base station or radio access point 108 according to some embodiments is shown with respect to FIG. 5. The base station 108 in some embodiments may comprise a ground noise threshold determiner 351, an interference strength determiner 353, an interference frequency determiner 355, and an interference distance/direction/position determiner 357.

The ground noise threshold determiner 351 in some embodiments is configured to define a runtime ground noise threshold for different physical resource blocks (PRBs).

The interference strength determiner 353, may be configured such that it is not enabled where a received ground noise is below the ground noise threshold but to determine or estimate an interference signal strength occurring within an expected window period for a PRB when the ground noise is greater than the threshold for that PRB. Furthermore when the received signal strength exceeds configured runtime ground noise thresholds on PRBs then these disturbed PRBs can be reserved and are not allocated to any UEs within the cell during the time window in order to enable an interference source only measurement to be made.

The interference frequency determiner 355 similarly in some embodiments is configured to determine or estimate an interference signal frequency occurring within an expected PRB window period.

The interference distance/direction/position determiner 357 may be configured to perform interference source parameter estimation based on at least one of the determined interference signal strength, the determined interference signal frequency and any implicit base station antenna direction. In some embodiments the distance and direction values may be determined in a manner similar to that described with respect to the radar system interference determination. Thus for example a free space path loss distance determination may be performed and the location or position of the interference source estimated from combining more than one of the distance estimates.

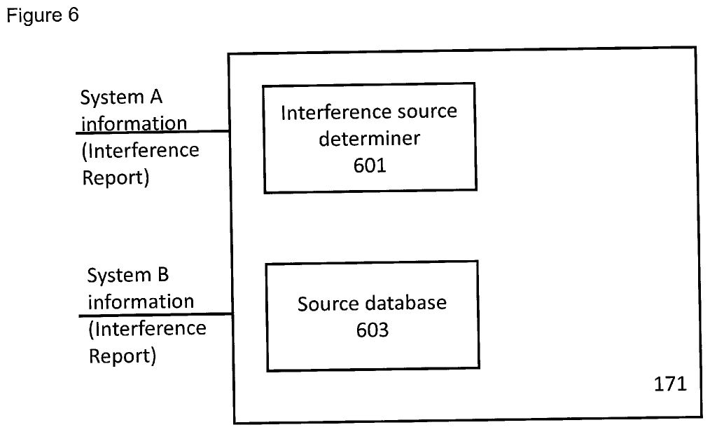

With respect to FIG. 6 is shown an example functional schematic view of a location server database 171 according to some embodiments. The location server database 171 may comprise a series of inputs for receiving information from the various radio based systems. Thus for example as shown in FIG. 6 the location server database 171 comprises separate inputs for receiving radio system A (for example radar system 161) information and receiving radio system B (for example base station 108) information. In some embodiments the location server database 171 comprises a single input for receiving all radio system information.

The system information received from the various systems may be interference reports, for example an estimate of strength, frequency, and location of the interference source. In some embodiments the system information may furthermore comprise a system registration report or a system update report identifying the location, type and transmitting power (and/or other parameters for identifying the transmitter of the radio system).

The location server database 171 in some embodiments comprises a source database 603. The source database in some embodiments is configured to receive the system registration reports and system update reports from the radio systems and store these within a suitable storage apparatus, for example a local, remote or distributed store.

The location server database 171 furthermore in some embodiments comprises an interference source determiner 601. The interference source determiner 601 in some embodiments is configured to receive interference reports and the information on the interference source (for example the interference source estimated location, estimated strength and estimated frequency). The interference source determiner 601 is then configured to search the source database 603 to determine whether there is a match between the interference source and the parameters stored within the source database.

For example the interference source determiner 601 with the assistance of the source database 603 may be able to determine whether the location of the interference source is near to a known radio system and thus attempt to identify the interference source as the radio system within the source database 603.

Similarly in some embodiments the interference source determiner 601 with the assistance of the source database 603 may be able to determine whether the frequency of the interference source approximate to the radio system frequency or a harmonic of the frequency where there are multiple radio systems operating near to the estimated interference source location in order to attempt to identify the origin of the interference.

The interference source determiner 601 having identified the radio source likely to be interfering, may be configured to perform some type of response. For example where the identified source is able to be remotely controlled (for example a base station within a cellular system) then a suitable control message may be generated or the control entity controlling the identified radio system may be informed. Where the identified source is not able to be remotely controlled a suitable report may be generated and forwarded to be further investigated.

In some embodiments where the interference source is not able to be identified from the source database 603, because the estimated location of the interference source has no registered radio systems present or nearby then it is likely that it is an illegal radio device (for example a ‘pirate’ radio broadcast) or an enemy device (for example a radar system of an aircraft within home airspace). In such examples the interference source determiner 601 may be able to generate a suitable output identifying the source as a non-identified radio source. For example generating a report to be investigated further. Additionally in some embodiments these non-identified radio sources may then be entered into the source database to determine if there is an identified regularity to the interference source. For example does the non-identified radio source occur at a regular and predicable time and/or location.

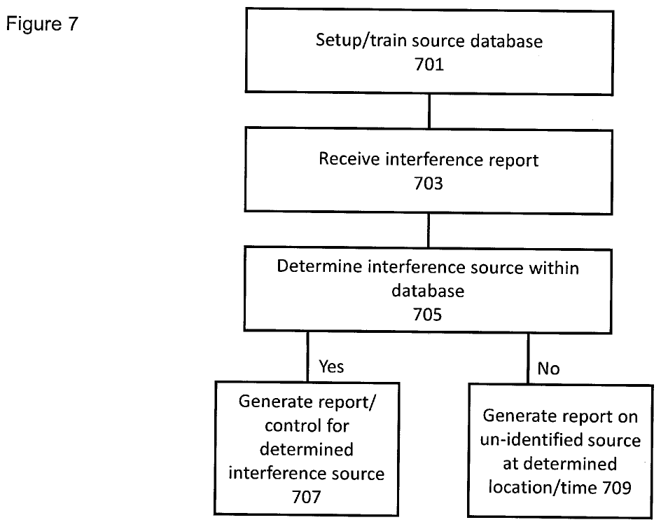

With respect to FIG. 7 a flow diagram showing the operations of an example location source database.

The first operation is one of setting up/training the source database. This may for example comprise the receiving of system registration reports and system update reports from the radio systems and store these within a suitable storage apparatus. In some embodiments this is a one off initialization operation. In other embodiments this setting up/training is carried out on a regular basis or in response to update reports.

The operation of the setting up/training of the source database is shown in FIG. 7 by step 701.

The following operations may then occur on receiving an interference report.

The operation of receiving the interference report is show in FIG. 7 by step 703.

Having received the interference report the next operation is one of determining or attempting to identify the interference source based on the source database information.

The operation of attempting to identify the interference source based on the source database information is shown in FIG. 7 by step 705.

When the interference source is positively identified then a suitable report/control can be generated for the determined interference source.

The generation of a suitable report/control when the interference source is positively identified is shown in FIG. 7 by step 707.

When the interference source is not positively identified then a suitable report/control can be generated for the un-identified interference source.

The generation of a suitable report/control for the non-identified interference source is shown in FIG. 7 by step 709.

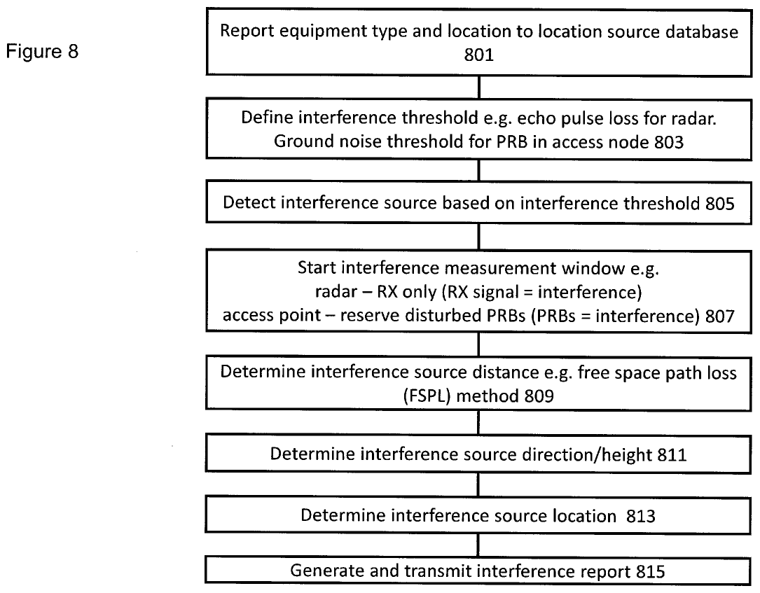

Furthermore with respect to FIG. 8 is shown the operation of the radio systems in generating suitable registration/update reports and interference source reports which may be forwarded to the location source database.

In some embodiments the radio system on initialization and/or update (for example when moving position or changing transmitter strength/frequency etc.) is configured to generate a suitable system registration/update report to be forwarded to the location source database. For example the report may be configured to report the equipment type and location.

The operation of generating and forwarding a suitable system registration/update report to the location source database is shown in FIG. 8 by step 801.

The radio system may then be configured to define or set a suitable interference threshold value. For example echo pulse loss value for a radar system, a ground noise threshold for an access node etc. The operation of defining the interference threshold value for the system is shown in FIG. 8 by step 803.

The following operation is one in which the system detects an interference source based on the interference threshold. The operation of detecting an interference source based on the interference threshold is shown in FIG. 8 by step 805.

Having detected the interference the next operation is one of starting an interference measurement window. The window may for example be during a receive only part of the radar system or part of a reserved physical resource block for an access point such as a base station.

The starting of the interference measurement window is shown in FIG. 8 by step 807.

The next operations are those of determining characteristics associated with the interference source by the measurement of radio parameters. For example the operation of determining an interference source distance (for example using a free space path loss estimation) is shown in FIG. 8 by step 809. Furthermore in some embodiments there is a determination of the interference source direction (which may be an azimuth and/or height determination) as shown in FIG. 8 by step 811. Furthermore in some embodiments there is a determination of the interference source location such as shown in FIG. 8 by step 813.

Although the examples shown herein show a separate registration/update report message and an interference report message operation in some embodiments the registration/update and interference report messages may be parts of the same message or data stream from one system or apparatus to another system or apparatus.

Having determined various characteristics of the interference source from the measurement of the radio parameters a report may be generated and transmitted, for example to the location source database. The report may comprise the determined characteristics such as location, distance, strength, frequency etc. The operation of generating and transmitting the interference report is shown in FIG. 8 by step 815.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are caused to perform the embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. An apparatus comprising at least one processor, and at least one memory including computer program code, wherein the at least one memory and the computer program code are configured, with the at least one processor, to cause the apparatus to:
generate at least one message for a further apparatus, the at least one message comprising information associated with at least one radio characteristic of the apparatus;
define at least one radio interference threshold value;
receive a radio signal having a signal value greater than the at least one radio interference threshold value, the radio signal being a radio signal originating from a radio system type other than the apparatus; and
measure the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

2. The apparatus as claimed in claim 1, caused to generate at least one message for a further apparatus, the at least one message comprising information associated with at least one radio characteristic of the apparatus is caused to generate the at least one message comprising at least one of:
an apparatus location;
an apparatus radio transmitter frequency; or
an apparatus radio transmitter strength.

3. The apparatus as claimed in claim 1, caused to define at least one radio interference threshold value is caused to:
define at least one echo pulse loss threshold where the apparatus is a radar apparatus; and
define a runtime ground noise threshold where the apparatus a cellular access point.

4. The apparatus as claimed in claim 1, wherein the apparatus caused to measure the radio signal to determine at least one radio signal characteristic is caused to determine at least one of:
an estimated interference source radio signal strength based on the received radio signal;
an estimated interference source radio signal frequency based on the received radio signal;
an estimated interference source direction based on the received radio signal;
an estimated interference source distance based on the received radio signal; or
an estimated interference source location based on the received radio signal.

5. The apparatus as claimed in claim 1, is further caused to generate at least one distance message to an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

6. The apparatus as claimed in claim 1, further caused to control the use of a radio frequency and/or time associated with radio signal such that the apparatus caused to measure the radio signal to determine at least one radio signal characteristic is caused to measure the radio signal when the apparatus or a radio system comprising the apparatus is active at the same frequency and/or time.

7. The apparatus as claimed in claim 1, wherein the apparatus caused to generate at least one message for a further apparatus, the at least one message comprising information associated with at least one radio characteristic of the apparatus and further comprising information associated with the at least one radio signal characteristic such that, the further apparatus is caused to attempt to identify the radio signal based on the information associated with the at least one radio signal characteristic is caused to:
generate a first, registration and/or update report, message comprising information associated with at least one radio characteristic of the apparatus; and
generate a separate further, interference report, message comprising information associated with the at least one radio signal characteristic such that the further apparatus is caused to attempt to identify the radio signal based on the information associated with the at least one radio signal characteristic.

8-14. (canceled)

15. A method comprising:
generating, at an apparatus, at least one message for a further apparatus, the at least one message comprising information associated with at least one radio characteristic of the apparatus;
defining at least one radio interference threshold value;
receiving a radio signal having a signal value greater than the at least one radio interference threshold value, the radio signal being a radio signal originating from a radio system type other than the apparatus; and
measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

16. The method as claimed in claim 15, wherein generating, at an apparatus, at least one message for a further apparatus, the at least one message comprising information associated with at least one radio characteristic of the apparatus comprises generating the at least one message comprising at least one of:
an apparatus location;
an apparatus radio transmitter frequency; or
an apparatus radio transmitter strength.

17. The method as claimed in claim 15, wherein defining at least one radio interference threshold value comprises:
defining at least one echo pulse loss threshold where the apparatus is a radar apparatus; and
defining a runtime ground noise threshold where the apparatus a cellular access point.

18. The method as claimed in claim 15, wherein measuring the radio signal to determine at least one radio signal characteristic comprises determining at least one of:
an estimated interference source radio signal strength based on the received radio signal;
an estimated interference source radio signal frequency based on the received radio signal;
an estimated interference source direction based on the received radio signal;
an estimated interference source distance based on the received radio signal; or
an estimated interference source location based on the received radio signal.

19. The method as claimed in claim 15, further comprising generating, at the apparatus, at least one distance message for an interference source determiner, the at least one distance message comprising information associated with an estimate of the distance of the radio signal such that the interference source determiner is caused to receive two or more distance messages from two or more separate apparatus and caused to estimate a radio signal location based on the two or more distance messages and the location of the two or more separate apparatus.

20. The method as claimed in claim 15, further comprising controlling the use of a radio frequency and/or time associated with radio signal such that measuring the radio signal to determine at least one radio signal characteristic comprises measuring the radio signal when the apparatus or a radio system comprising the apparatus is active at the same frequency and/or time.

21. The method as claimed in claim 15, wherein generating, at the apparatus, at least one message for a further apparatus, the at least one message comprising information associated with at least one radio characteristic of the apparatus and further comprising information associated with the at least one radio signal characteristic such that the further apparatus is caused to attempt to identify the radio signal based on the information associated with the at least one radio signal characteristic comprises:
generating a first, registration and/or update report, message comprising information associated with at least one radio characteristic of the apparatus; and
generating a separate further, interference report, message comprising information associated with the at least one radio signal characteristic such that the further apparatus is caused to attempt to identify the radio signal based on the information associated with the at least one radio signal characteristic.

22.-56. (canceled)

57. A non-transitory computer readable medium comprising program instructions for causing an apparatus to perform at least the following:
generating at least one message for a further apparatus, the at least one message comprising information associated with at least one radio characteristic of the apparatus;
defining at least one radio interference threshold value;
receiving a radio signal having a signal value greater than the at least one radio interference threshold value, the radio signal being a radio signal originating from a radio system type other than the apparatus; and
measuring the radio signal to determine at least one radio signal characteristic, wherein the at least one message for the further apparatus further comprises information associated with the at least one radio signal characteristic such that the further apparatus is caused to attempt to identify the radio signal based on the information associated with the at least one radio signal characteristic.

58. The computer readable medium as claimed in claim 57, wherein generating at least one message for a further apparatus, the at least one message comprising information associated with at least one radio characteristic of the apparatus causes an apparatus to perform generating the at least one message comprising at least one of:
an apparatus location;
an apparatus radio transmitter frequency; or
an apparatus radio transmitter strength.

59. The computer readable medium as claimed in claim 57, wherein defining at least one radio interference threshold value causes an apparatus to perform:
defining at least one echo pulse loss threshold where the apparatus is a radar apparatus; and
defining a runtime ground noise threshold where the apparatus a cellular access point.

60. The computer readable medium as claimed in claim 57, wherein measuring the radio signal to determine at least one radio signal characteristic causes an apparatus to perform determining at least one of:
an estimated interference source radio signal strength based on the received radio signal;
an estimated interference source radio signal frequency based on the received radio signal;
an estimated interference source direction based on the received radio signal;
an estimated interference source distance based on the received radio signal; or
an estimated interference source location based on the received radio signal.

61. The computer readable medium as claimed in claim 57, further causing an apparatus to perform at least the following generating at least one distance message for an interference source determiner, the at least one distance message comprising information associated with an estimate of the distance of the radio signal such that the interference source determiner is caused to perform receiving two or more distance messages from two or more separate apparatus and estimating a radio signal location based on the two or more distance messages and the location of the two or more separate apparatus.

62. The computer readable medium as claimed in claim 57, further causing an apparatus to perform at least the following controlling the use of a radio frequency and/or time associated with radio signal such that measuring the radio signal to determine at least one radio signal characteristic causes an apparatus to perform measuring the radio signal when the apparatus or a radio system comprising the apparatus is active at the same frequency and/or time.

63.-70. (canceled)
